(19) United States
(12) Patent Application Publication
(10) Pub. No.: US 2015/0353139 A1
(43) Pub. Date: Dec. 10, 2015

(54) REINFORCING AGENT FRAME STRUCTURE AND VEHICLE

(71) Applicant: GM GLOBAL TECHNOLOGY OPERATIONS LLC, Detroit, MI (US)

(72) Inventor: Roland LEBMEISTER, Otterberg (DE)

(73) Assignee: GM GLOBAL TECHNOLOGY OPERATIONS LLC, Detroit, MI (US)

(21) Appl. No.: 14/730,908

(22) Filed: Jun. 4, 2015

(30) Foreign Application Priority Data
Jun. 4, 2014 (DE) 202014004746.4

(51) Int. Cl. B62D 25/04; B62D 27/02

(52) U.S. Cl. CPC B62D 25/04; B62D 27/023

(57) ABSTRACT

A reinforced frame structure such as vehicle pillar and more particularly a hinge pillar region for a motor vehicle is disclosed. The reinforced frame structure includes at least one substantially planar reinforcement member positioned within an outer floor section by an inner base profile forming the cavity. The reinforcement member is arranged with a first coupling portion between the outer bottom profile and the inner bottom section for securing these sections. A second coupling portion is formed on the outer bottom profile and/or at the inner bottom section and is particularly dimensionally fitted, fixed or defined.

### CROSS REFERENCE TO RELATED APPLICATION

This application claims priority to German Patent Application No. 202014004746.4 filed Jun. 4, 2014, which is incorporated herein by reference in its entirety.

### TECHNICAL FIELD

The present disclosure pertains to a reinforcing means for a frame structure, such as a vehicle pillar, in particular in the area of a hinge pillar, a motor vehicle, a frame structure with such a reinforcing means, as well as a motor vehicle with such a reinforcing means and/or with such a frame structure.

### BACKGROUND

In known frame structures, a conventional lower A.-pillar concept encompasses at least five sheet metal parts, which are joined or spot welded with the lower hinge pillar region or A-pillar hub. As a result, a high number of individual components must be kept available, and each of the components must be individually assembled and mounted, which is also cumbersome and time intensive.

In order to reduce the number of parts and simplify the assembly of different components, DE 10 2011 117 951 A1 proposed an S-shaped reinforcing body, which is fixed in place in the floor profile of a frame structure by means of an adhesive agent.

### SUMMARY

According to one embodiment a reinforcing means for a frame structure is proposed as well as a frame structure with such a reinforcing means, which offers an alternative, functional construction.

A reinforcing means for a frame structure, such as a vehicle pillar, in particular in the area of a hinge pillar, of a motor vehicle is provided with at least one reinforcing body that essentially covers the surface, which can be arranged or is arranged inside a hollow space formed by an outer floor profile and by an inner floor profile, which can be fixed in place at least with a first coupling section by means of a first fixing means of the frame structure between the outer floor profile and inner floor profile and on both floor profiles, in particular so as to abut against the surface, and which can be fixed in place or is fixed in place at least with a second coupling section by means of a second fixing means of the frame structure on the outer floor profile and/or on the inner floor profile, in particular so as to abut against the surface.

Because the first coupling section of the reinforcing body can be fixed in place by means of the first fixing means between the outer floor profile with the inner floor profile and on both floor profiles, the reinforcing body is integrated into a joint to be provided anyway between the outer floor profile and inner floor profile. As a result, no fixing means need be provided exclusively to fix the reinforcing body in place, and fixing means that are present anyway can be drawn upon instead.

Because at least one second coupling section of the reinforcing body can be fixed in place so as to abut against the surface on the outer floor profile and/or on the inner floor profile, the fixing means necessary for joining the outer and inner floor profile can also be drawn upon there, or, depending on the available required space, the reinforcing body can also be fixed in place on just one of the two floor profiles. As a result, the process of fixing the reinforcing body in place within the hollow space can be flexibly designed.

It is basically conceivable for the reinforcing body to extend along the complete direction of extension of the inner and outer floor profile, as viewed in the traveling direction of the motor vehicle. In addition, it is conceivable for it to only extend along a partial area of the inner floor profile and outer floor profile. Viewed in the traveling direction, the reinforcing body preferably comprises at least one extension that encompasses double the width of the A-pillar.

The reinforcing body can extend in any desired direction within the hollow space. The frame structure can be manufactured to be lighter and compact by having the reinforcing body extend essentially along a primary direction of extension that runs from a vehicle floor in the direction of the vehicle roof.

It further proves advantageous for the first coupling section of the reinforcing body to be arranged to run essentially in or parallel to the primary direction of extension and/or for the second coupling section of the reinforcing body to encompass at least one transverse area, which is arranged to run essentially transverse to the primary direction of extension and/or for the second coupling section of the reinforcing body to encompass at least one second longitudinal area, which is arranged to run essentially in or parallel to the primary direction of extension.

If the first coupling section is arranged to run transverse to the primary direction of extension, and the second transverse area of the second coupling section to run transversely to the primary direction of extension, the reinforcing body in this area encompasses an L-shaped cross section viewed transverse to the traveling direction.

If the first coupling section and/or the second coupling section, in particular with its second longitudinal area, is arranged to run in or parallel to the primary direction of extension, both the second coupling section and the first coupling section are in this area arranged to run in or parallel to the (primary direction of extension. The second longitudinal area of the second coupling section as well as the first coupling section can here be arranged to align one into the other or be offset parallel to each other.

In such a case, both the first coupling section and second coupling section can be fixed in place on the inner floor profile and on the outer floor profile so as to abut against the surface. In such a case, the reinforcing body is fixed in place by means of a flange formed anyway between the inner floor profile and outer floor profile, so that no additional fixing means need be provided, and the fixing means used anyway between the inner floor profile and outer floor profile can be drawn upon instead.

The reinforcing body can have a solid design. In addition, it is conceivable for the reinforcing body to encompass at least one continuous recess, in particular one that runs transverse to the primary direction of extension.

The at least one recess makes it possible to give the reinforcing body a more lightweight design. The at least one recess can basically encompass any contour desired. For example, the latter can be n-cornered, arc-shaped and/or rounded. For example, at least one of the at least one recesses can have an essentially quadrangular design. The lateral edges can here converge at an angle or merge into each other in a rounded manner. The advantage to providing a rounded corner is that it reduces the danger of crack formation.

The reinforcing body, the inner floor profile along with the outer floor profile can basically encompass any contour desired as well as any material desired. The cost-effective manufacture of the frame structure can be ensured by having the inner floor profile, outer floor profile and/or reinforcing body encompass a bent-pressed part, in particular a sheet metal bent-pressed part.

In order to further increase the stability of the frame structure, it proves advantageous for the reinforcing body to encompass at least one third coupling section, which can be fixed in place on at least one front wall profile by means of a third fixing means of the frame structure, in particular so as to abut against the surface.

The first fixing means, second fixing means and/or third fixing means can essentially be designed however desired, as long as it satisfies the function of fixing the inner floor profile, outer floor profile and reinforcing in place on each other. In such a case, the first fixing means, second fixing means and/or third fixing means can encompass a detachable and undetachable bond. The first fixing means, second fixing means and/or third fixing means can be fabricated easily and with a tighter weight by having the first fixing means, second fixing means and/or third fixing means encompass a welded joint, in particular a spot welded joint.

This makes it possible to achieve a spot welded joint with three metal sheets in the area of the first fixing means. A spot welded joint with three metal sheets can also be achieved in the second longitudinal area of the second coupling section of the reinforcing body. A spot welded joint with two metal sheets can be achieved in particular in the second transverse area. of the second coupling section of the reinforcing body.

The stability of the reinforcing means can be further increased by having the reinforcing body encompass at least one reinforcing section that runs in the primary direction of extension and a deformation transverse to the primary direction of extension.

A frame structure is further provided, with at least one outer floor profile, with at least one inner floor profile, and with a reinforcing body, which can be arranged or is arranged within a hollow space formed by the outer floor profile and by the inner floor profile, which can be fixed in place at least with a first coupling section by means of the first fixing means between the outer floor profile and inner floor profile and on both floor profiles, in particular so as to abut against the surface, and which can be fixed in place or is fixed in place at least with a second coupling section by means of the second fixing means on the outer floor profile and/or on the inner floor profile, in particular so as to abut against the surface.

Finally, a frame structure is provided with at least one reinforcing means.

The reinforcing means, the frame structure along with the motor vehicle prove advantageous from a variety of standpoints.

Because the reinforcing body extends through a hollow space formed between the inner floor profile and outer floor profile, and its first coupling section can be arranged in a second coupling section both on the inner floor profile as well as on the outer floor profile, the stability of the frame structure can be increased. The fact that the reinforcing body extends through almost the entirety of the hollow space in the primary direction of extension raises the forces that can be absorbed by the reinforcing structure, and increases the loading capacity of the frame structure.

Because the reinforcing body encompasses at least one continuous recess that runs transverse to the primary direction of extension, the weight of the reinforcing means and frame structure can be reduced while retaining virtually the same force absorption.

### BRIEF DESCRIPTION OF THE DRAWINGS

The present invention will hereinafter be described in conjunction with the following drawing figures, wherein like numerals denote like elements, and:

FIG. 1 is a perspective side view of part of the frame structure;

FIG. 2 is a sectional view of a frame structure along the A-A line of a frame structure;

FIG. 3 shows the frame structure according to FIG. 1 with spot welded joints.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

The figures show a frame structure marked with reference number 2 overall, such as a vehicle pillar, in particular in the area of a hinge pillar, of a motor vehicle. The frame structure 2 encompasses an outer floor profile 4 and an inner profile 6 indirectly or directly joined with the outer floor profile 4. A hollow space 8 is formed between the outer floor profile 4 and inner floor profile 6. Arranged in the high hollow space 8 is a reinforcing body 10 of a reinforcing means 12, which essentially extends along a primary direction of extension 14 that runs from a vehicle floor in the direction of the vehicle roof.

A first coupling section 16 of the reinforcing body 10 is here fixed in place between the inner floor profile 6 and outer floor profile 4 and on the latter so as to abut against the surface by means of a first fixing means 18. In addition, the reinforcing body 10 can be fixed in place with a second coupling section 20 at least on the outer floor profile.

In the exemplary embodiment shown on the figure, the second coupling section 20 of the reinforcing body 10 encompasses a second transverse area 22, which is arranged to run essentially transverse to the primary direction of extension 14, and fixed in place on the outer floor profile 4 so as to abut against the surface, in addition, the second coupling section 20 exhibits a second longitudinal area 24, which is arranged to run essentially in or parallel to the primary direction of extension 14, and is fixed in place both on the outer floor profile 4 and on the inner floor profile 6 so as to abut against the surface. To this end, the frame structure 2 encompasses a second fixing means 26, which can be used to fix in place both the second transverse area 22 and second longitudinal area 24 of the second coupling section 20.

The first fixing means 18 and second fixing means 26 each encompass spot welded joints.

In addition, the reinforcing body 10 encompasses two continuous recesses 28 that run transverse to the primary direction of extension 14.

In order to further increase the force absorption of the reinforcing means 12, it exhibits a reinforcing section 30 that extends in primary direction of extension 14 and encompasses a deformation transverse to the primary direction of extension 14.

The reinforcing body 10 of the reinforcing means 12 further encompasses a third coupling section 32, which is fixed in place on a front wall profile 36 so as to abut against the surface by means of a third fixing means 34.

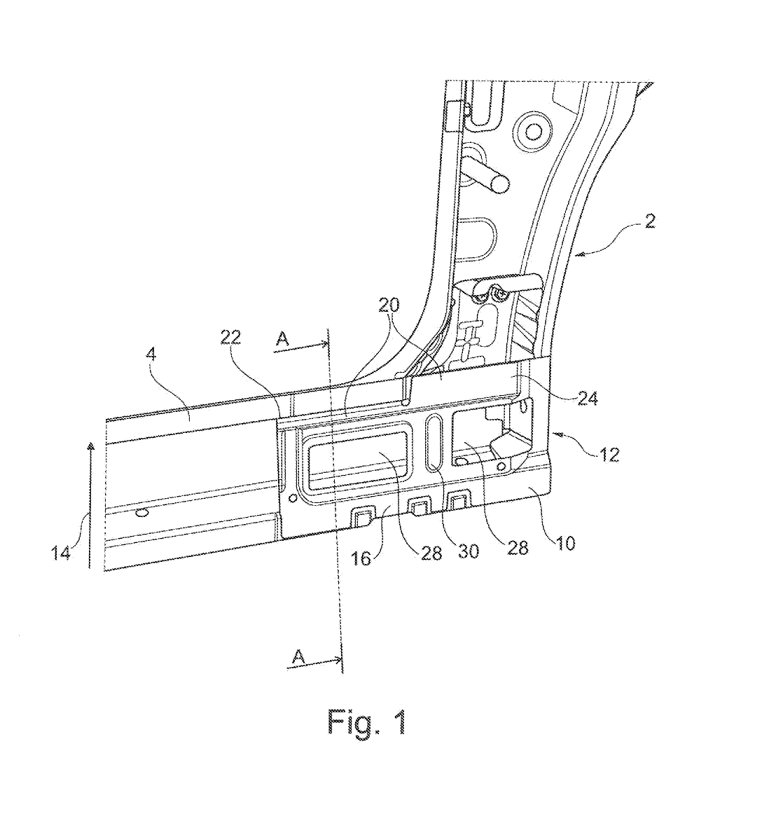

FIG. 1 presents a lateral perspective view of part of the frame structure 2, in which in particular the inner floor profile 6 is hidden. As evident from FIG. 1, the reinforcing body 10 extends in its entirety over the hollow space 8 formed by the outer floor profile 4 and inner floor profile 6 as viewed in the direction of extension 14. As a result, it is fixed in place both at the bottom and top on the outer hollow floor profile 4 and inner floor profile 6, so that hollow forces can be absorbed. The reinforcing section 30 is also arranged in the direction of extension 14, making it possible to achieve an increase in the flexural rigidity of the reinforcing body in the direction of the highest load to be absorbed, namely opposite the direction of extension 14. As further evident from FIG. 1, the second coupling section 20 exclusively encompasses the second longitudinal area 24 in the area of the pillar, in particular the A-pillar. By contrast, the second coupling section 20 is offset relative to the pillar area, and encompasses the second transverse area 22.

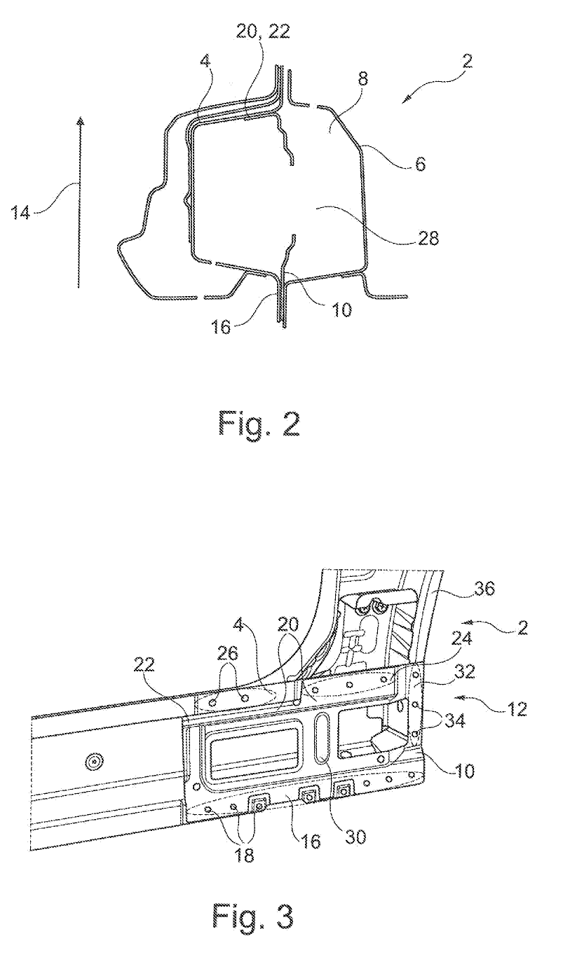

FIG. 2 presents a section along the A-A line on FIG. 1, while the inner floor profile 6 is inserted, in contrast to FIG. 1. As clearly evident here, the first coupling section 16 of the reinforcing body 10 is fixed in place both on the inner floor profile 6 and on the outer floor profile 4 so as to abut against the surface by means of the first fixing means 18 designed as a spot welded joint. By contrast, the second coupling section 20 formed by the second transverse area 22 abuts exclusively against the outer floor profile 4 so as to cover the surface.

FIG. 3 presents a magnified view of the subject matter according to FIG. 1, with the difference being that the first fixing means 18, the second fixing means 26 along with the third fixing means 34 are additionally depicted. As evident here, the fixing means encompass spot welded joints.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents. Thus, the features presented in the above specification, in the claims and in the drawings can be significant for implementing the invention and its various embodiments, both taken individually and in any combination desired.

1-10. (canceled)

11. A reinforcing member for a frame structure comprising:
a reinforcing body covering a surface of the frame structure and arranged inside a hollow space formed by an outer floor profile and by an inner floor profile, the reinforcing body having a first coupling section and a second coupling section;
a first fastening element fixing the first coupling section between the outer floor profile and inner floor profile so as to abut against the surface; and
a second fastening element fixing the second coupling section between at least one of the outer floor profile and on the inner floor profile so as to abut against the surface.

12. The reinforcing member according to claim 11, wherein the reinforcing body extends along a primary direction of extension that runs from a vehicle floor in the direction of the vehicle roof.

13. The reinforcing member according to claim 11, wherein the first coupling section of the reinforcing body arranged to run parallel to the primary direction of extension and the second coupling section of the reinforcing body includes at least one transverse area arranged to run transverse to the primary direction of extension and at least one second longitudinal area arranged to run parallel to the primary direction of extension.

14. The reinforcing member according to claim 11, wherein the reinforcing body includes at least one continuous recess that runs transverse to the primary direction of extension.

15. The reinforcing member according to claim 11, wherein at least one of the inner floor profile, the outer floor profile and the reinforcing body comprises a sheet metal bent-pressed part.

16. The reinforcing member according to claim 11, wherein the reinforcing body includes at least one third coupling section fixed in place on a front wall profile with a third fastening element so as to abut against the surface.

17. The reinforcing member according to claim 11, wherein the first fastening element and the second fastening element comprise a welded joint.

18. The reinforcing member according to claim 11, wherein the reinforcing body further comprises at least one reinforcing section running in the primary direction of extension and a deformation transverse to the primary direction of extension.

19. A vehicle pillar structure for a motor vehicle comprising:
a frame structure having an outer floor profile and an inner floor profile forming a hollow space therebetween and defining an inner surface having a first fastening region and a second fastening region;
a reinforcing member having a reinforcing body covering the and arranged inside the hollow space formed by the outer floor profile and the inner floor profile, the reinforcing body having a first coupling section and a second coupling section;
a first fastening element fixing the first coupling section with the first fastening region and between the inner and outer floor portions; and
a second fastening element fixing the second coupling section with the second fastening region of the inner surface.

20. motor vehicle having at least one vehicle pillar structure according to claim 19.
